(19) United States
(12) Patent Application Publication
(10) Pub. No.: US 2005/0051138 A1
(43) Pub. Date: Mar. 10, 2005

(54) Intake manifold assembly

(75) Inventors: John W. Haley, Rochester, MI (US); Maria Catherine Nowland, Brighton, MI (US)

Correspondence Address: MICHAEL BEST & FRIEDRICH LLP, 100 EAST WISCONSIN AVENUE, MILWAUKEE, WI, 53202, US

(73) Assignee: Robert Bosch Corporation, Broadview, IL (US)

(21) Appl. No.: 10/657,443

(22) Filed: Sep. 8, 2003

(51) Int. Cl. F02M 55/02; F02M 61/14

(52) U.S. Cl. 123/468; 123/470

(57) ABSTRACT

An intake manifold assembly includes an intake manifold having an intake passageway and a fuel injector in communication with the intake passageway. At least a portion of the fuel injector is molded into the intake manifold such that liquid fuel and hydrocarbon emissions are substantially prevented from leaking outside of the intake manifold.

### FIELD OF THE INVENTION

The invention relates to intake manifold assemblies for internal combustion engines.

### BACKGROUND OF THE INVENTION

An intake manifold assembly supplies a mixture of fuel and air to a combustion chamber of an internal combustion engine. Typically, an intake manifold assembly includes an intake manifold, multiple fuel injectors coupled to the intake manifold, and a fuel rail coupled to the fuel injectors to deliver fuel to the fuel injectors. The fuel injectors are coupled to the intake manifold such that individual fuel injectors discharge fuel into respective intake runners formed in the intake manifold. Typically, fuel injector pockets aligned with the individual intake runners are formed in the intake manifold to receive the fuel injectors, and seals are used adjacent the outlet ends of the fuel injectors to seal the interface between the fuel injectors and the fuel injector pockets such that air and fuel vapor are prevented from leaking from the intake manifold.

The fuel injectors are typically secured to the fuel rail using clips, or other known attachment means. Each fuel injector includes a seal adjacent the inlet end of the fuel injector. The seal functions to seal the interface between the fuel injector and the fuel rail such that liquid fuel is prevented from leaking from the fuel rail at the fuel rail/fuel injector interface. The fuel rail and injector assembly is then coupled to the intake manifold by using conventional fasteners, or other known attachment means, such that the fuel injectors are secured in place between the intake manifold and the fuel rail.

### SUMMARY OF THE INVENTION

While the seals in prior art intake manifold assemblies substantially prevent leakage of liquid fuel, evaporative hydrocarbons are still sometimes emitted around or directly through the resilient seals. With the recent push toward reducing and eventually eliminating the emission of evaporative hydrocarbons from automobiles, the need exists for an intake manifold assembly that is substantially sealed to prevent the emission of evaporative hydrocarbons.

The intake manifold assembly of the present invention operates with substantially zero evaporative emissions and is well-suited for existing engine applications or for future engine applications in vehicles that are restricted from emitting hydrocarbons. In one embodiment, the present invention provides a fuel rail and fuel injectors that are secured to the fuel rail by welding, brazing, or other suitable methods. Welding or brazing the injectors to the fuel rail eliminates the need for the seals at the fuel rail/injector interfaces because the welding or brazing operations substantially seal the interfaces, thereby preventing fuel leakage. The welded or brazed interface also eliminates the emission of evaporative hydrocarbons that can otherwise occur around or directly through the resilient seals.

The intake manifold assembly of the invention may also include an electrical connector in the form of a bus-bar coupled to the fuel rail and to the injectors to provide electrical power to the injectors. The bus-bar is configured to provide a single multi-pin terminal that can be connected to a single multi-pin terminal of a fuel injector harness. The multi-pin terminal provides electrical power to all of the injectors.

Once the injectors are welded or brazed to the fuel rail, and electrical contacts are created between the injectors and the bus-bar, the fuel rail and the fuel injectors are positioned in a mold cavity, and an insert-molding process forms at least a portion of the intake manifold such that the fuel rail and the fuel injectors are molded into the intake manifold. As a result, the fuel rail, the electrical contacts created between the injectors and the bus-bar, and the fuel injectors are substantially encased and protected in the molded intake manifold. Further, the seals that are typically adjacent the fuel outlet of the fuel injector may be eliminated since insert molding the fuel injectors with the intake manifold eliminates the emission of evaporative hydrocarbons that can otherwise occur around or directly through the resilient seals adjacent the fuel outlet of the injectors. The intake manifold assembly of the present invention is compact, robust, substantially leak-proof, substantially emission-free, easy to transport, and easy to install.

More specifically, the invention provides an intake manifold assembly including an intake manifold having an intake passageway and a fuel injector in communication with the intake passageway. At least a portion of the fuel injector is molded into the intake manifold. In one aspect of the invention, the intake manifold assembly also includes a fuel rail defining therein a fuel passageway in communication with the fuel injector. At least a portion of the fuel rail is also molded into the intake manifold. In another aspect of the invention, the intake manifold assembly also includes an electrical connector coupled to the fuel injector to selectively transfer power to the fuel injector. The electrical connector is also at least partially molded into the intake manifold. The fuel injector may be entirely molded into the intake manifold such that liquid fuel transferred from the fuel passageway to the intake passageway via the fuel injector, and hydrocarbon emissions resulting from the transfer of fuel, are substantially prevented from leaking outside the intake manifold.

The invention also provides a method of manufacturing an intake manifold assembly. The method includes providing a fuel injector, inserting the fuel injector into a mold cavity, and forming at least a portion of an intake manifold in the mold cavity such that at least a portion of the fuel injector is molded into the intake manifold. The method may also include inserting the fuel rail into the mold cavity such that at least a portion of the fuel rail is molded into the intake manifold. Further, the method may include coupling an electrical connector to the fuel injector, and molding at least a portion of the electrical connector into the intake manifold. In addition, the method may further include insert-molding the entire fuel injector into the manifold such that liquid fuel provided to the fuel injector, liquid fuel discharged by the fuel injector, and hydrocarbon emissions resulting from evaporation of the fuel provided to the fuel injector and the fuel discharged by the fuel injector are substantially prevented from leaking outside of the intake manifold.

The invention further provides an intake manifold assembly including an intake manifold having an intake passageway and a fuel injector having a fuel inlet and a fuel outlet. The fuel outlet is in communication with the intake passageway. The intake manifold assembly also includes a fuel rail defining a fuel passageway in communication with the fuel inlet, and an electrical connector coupled to the fuel injector to selectively transfer power to the fuel injector. The electrical connector is at least partially molded into the intake manifold, such that an interface between the fuel passageway and the fuel inlet is molded into the intake manifold. The fuel outlet is molded into the intake manifold such that liquid fuel transferred from the fuel passageway to the intake passageway via the fuel injector, and hydrocarbon emissions resulting from the transfer of fuel, are substantially prevented from leaking outside the intake manifold.

In addition, the invention provides an engine assembly including an engine having a cylinder head, and an intake manifold assembly coupled to the cylinder head. The intake manifold assembly defines an air path for providing intake air to the cylinder head, a fuel path for providing fuel to the cylinder head, and an electrical path for providing power to the fuel injector. Each of the air path, the fuel path, and the electrical path are at least partially molded into the intake manifold assembly.

Other features and aspects of the present invention will become apparent to those skilled in the art upon review of the following detailed description, claims and drawings.

### BRIEF DESCRIPTION OF THE DRAWINGS

In the drawings, wherein like reference numerals indicate like parts:

FIG. 1 is a front perspective view of an intake manifold assembly of the present invention, the intake manifold assembly being partially cut away to expose a portion of a fuel rail assembly.

FIG. 2 is a rear perspective view of the intake manifold assembly of FIG. 1.

FIG. 3 is an exploded view of the intake manifold assembly of FIG. 1.

FIG. 4 is a partial cross-sectional view of the intake manifold assembly taken through line 4--4 of FIG. 2.

FIG. 5 is an enlarged view of a portion of the intake manifold assembly of FIG. 4.

FIG. 6 is a perspective view of the fuel rail assembly being positioned inside a mold cavity.

Before any features of the invention are explained in detail, it is to be understood that the invention is not limited in its application to the details of construction and the arrangements of the components set forth in the following description or illustrated in the drawings. The invention is capable of other constructions and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items.

### DETAILED DESCRIPTION

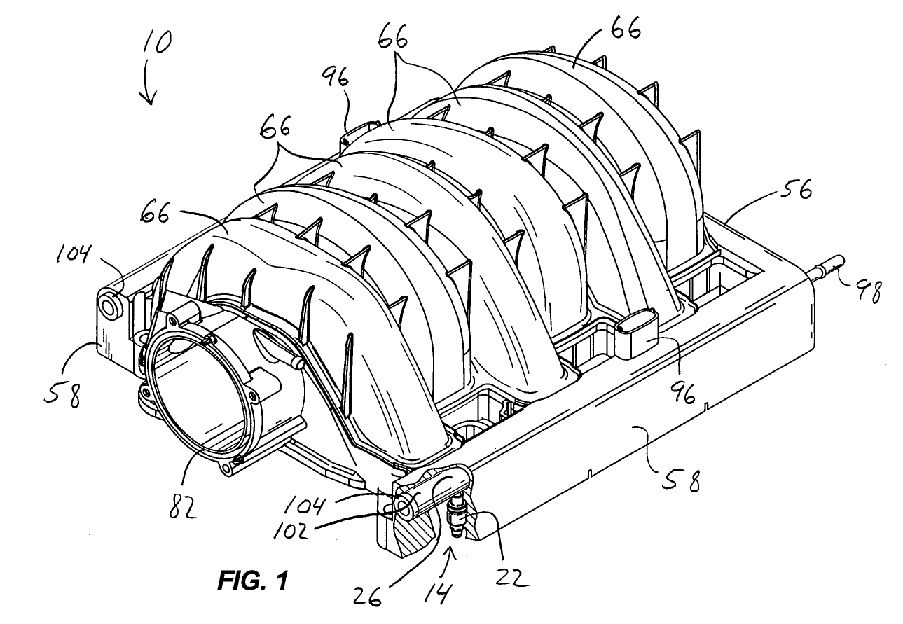

With reference to FIGS. 1-3, an intake manifold assembly 10 of the present invention is shown. As illustrated, the intake manifold assembly 10 is configured for use with a V-6 internal combustion engine (not shown), however, it is to be understood that the intake manifold assembly 10 may also be configured for use with other engine configurations (e.g., V-8 engines, in-line four cylinder engines, etc.).

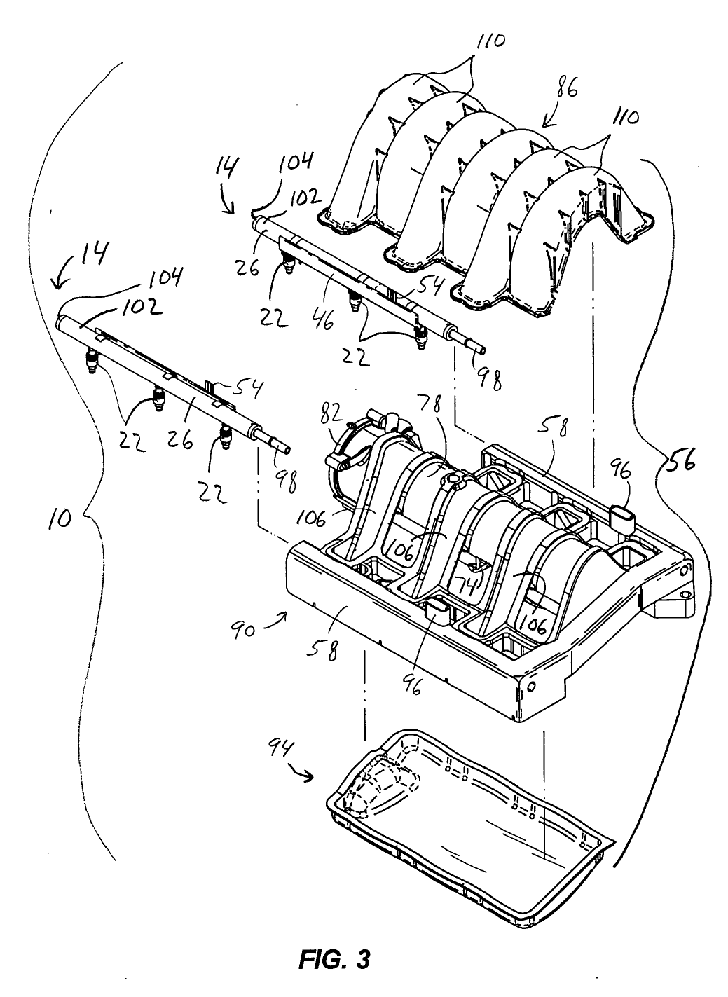

As best illustrated in FIG. 3, the intake manifold assembly 10 includes two fuel rail assemblies 14. The fuel rail assemblies 14 each include three fuel injectors 22 coupled in spaced relation to a fuel rail 26. The fuel rail 26 defines a fuel passageway 30 (see FIG. 5) for providing fuel to the fuel injectors 22. However, in other constructions of the intake manifold assembly 10, the fuel passageway 30 may be integrally formed with the intake manifold such that the fuel rail 26 may be omitted.

With reference to FIG. 5, the fuel injectors 22 each include a fuel inlet 34 and a fuel outlet 38, which is selectively fluidly connected with the fuel inlet 34 by an injector valve arrangement (not shown) that is selectively actuated by an electromagnetic coil assembly in a known manner. The fuel inlet 34 is fluidly connected with the fuel passageway 30 to receive fuel from the fuel passageway 30. In the illustrated construction, the fuel rails 26 are made from metal, and the fuel injectors 22 are permanently connected to the metal fuel rail 26 by a process such as laser welding, TIG welding, or brazing. As a result, a seal (e.g., an O-ring) adjacent the fuel inlet 34 is not required to seal the interface between the fuel passageway 30 and the fuel inlet 34 of the fuel injector 22.

Each of the fuel rail assemblies 14 also includes an electrical connector in the form of a bus-bar 46 that is coupled to the fuel rail 26. As shown in FIG. 5, the bus-bar 46 includes a plurality of elongated electrical leads 50 to provide electrical power to the coil assemblies of the injectors 22. Each lead 50 terminates on one end at a multi-pin terminal 54. The other end of each lead 50 is electrically connected to a fuel injector 22 to provide electrical signals to the coil assembly of that fuel injector 22 to actuate the injector valve. The fuel rail assemblies 14 shown and described herein are substantially similar to the fuel rail assemblies disclosed in U.S. Patent Application Publication No. 2003/0070658 (the “'658 Application”) published Apr. 17, 2003, the entire contents of which is hereby incorporated by reference. As such, reference is made to the '658 Application for additional discussion regarding the structure and operation of the fuel rail assemblies 14.

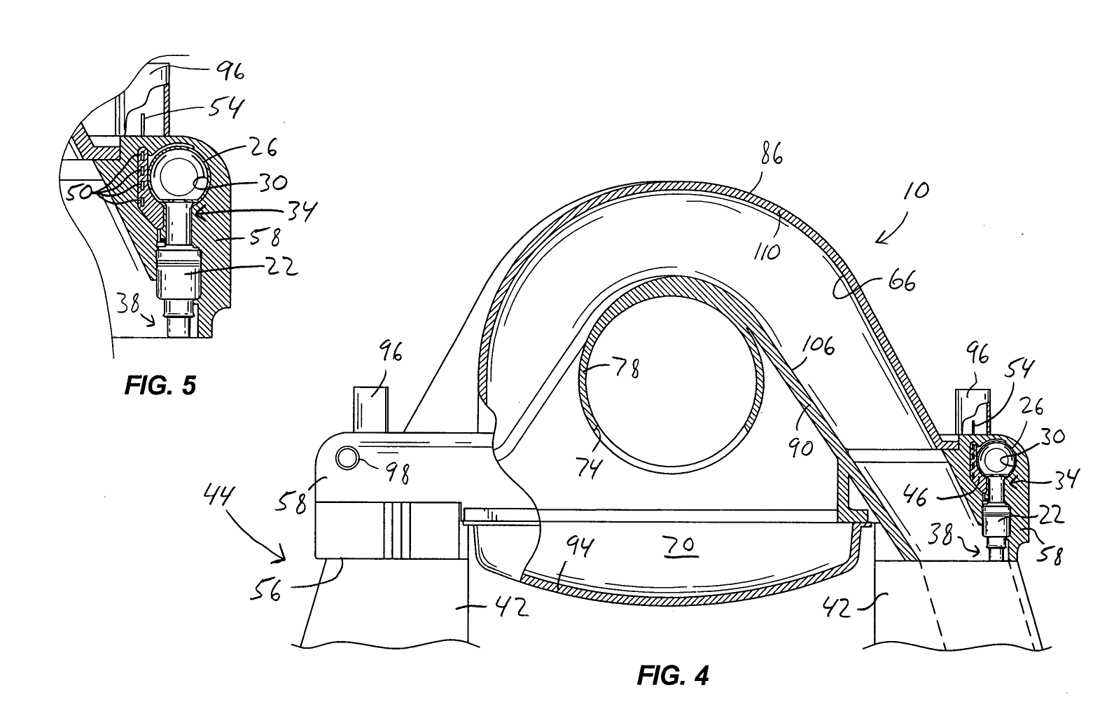

As shown in FIG. 4, the intake manifold assembly 10 also includes an intake manifold 56 configured to be mated to cylinder heads 42 of a V-6 engine 44 by two opposing base portions 58. The intake manifold 56 also includes multiple intake passageways or runners 66 fluidly connected to a plenum 70. The plenum 70 receives air through an opening 74 in an air inlet tube 78. A throttle body (not shown) is coupled to a throttle body flange 82 on the intake manifold 56 to provide air to the air inlet tube 78. As is understood in the art, the air in the plenum 70 is drawn into the individual cylinders in the engine via the intake runners 66 for the combustion process.

As understood from FIGS. 3 and 4, two banks of fuel injectors 22 (one bank on each fuel rail assembly 14) provide fuel to the respective banks of cylinders in the V-6 engine. The fuel outlet 38 of each fuel injector 22 is aligned and in fluid communication with a respective intake runner 66 to deliver a metered amount of fuel to the cylinder matched with the intake runner 66.

According to the present invention, at least a portion of each fuel injector 22, and more preferably substantially the entirety of each fuel injector 22 is molded into the intake manifold 56. The fuel injectors 22 are molded into the intake manifold 56 such that the interface between the fuel passageway 30 and the fuel inlet 34, and the interface between the fuel outlet 38 and the intake manifold 56 are molded into the intake manifold 56. As a result, a separate seal (e.g., an O-ring, not shown) adjacent the fuel inlet 34 and a separate seal (e.g., an O-ring, not shown) adjacent the fuel outlet 38 are not required, and no portion of the fuel injectors 22 are exposed to the ambient surroundings of the intake manifold 56 when the intake manifold 56 is secured to the cylinder heads of an engine. Liquid fuel transferred from the fuel passageways 30 to the intake runners 66 via the fuel injectors 22 is substantially prevented from leaking outside the intake manifold 56. Additionally, hydrocarbon emissions resulting from the transfer of fuel are also substantially prevented from escaping the intake manifold 56.

It is to be understood that while the illustrated embodiment shows substantially the entirety of each fuel injector 22 molded into the intake manifold 56, the present invention contemplates having less than each entire injector 22 molded into the intake manifold. For example, in one embodiment only the outlet end of each fuel injector 22 would be molded into the intake manifold 56. Such a construction would still provide a sealed interface between the fuel outlet 38 and the respective intake runner 66.

Referring again to the embodiment illustrated in FIGS. 1-5, at least a portion of each fuel rail 26, and more preferably substantially the entirety of each fuel rail 26 is also molded into the intake manifold such that the interface between the fuel passageway 30 and each respective fuel inlet 34 is substantially sealed to prevent leakage of liquid fuel and hydrocarbon emissions. In other embodiments, however, such as the one described above with only the outlet ends 38 of the injectors molded into the intake manifold 56, the fuel rails 26 need not be molded into the intake manifold 56. In yet other embodiments, the fuel rails 26 could be eliminated in favor of integrally forming one or more fuel passageways 30 directly in the intake manifold 56 during molding of the intake manifold 56.

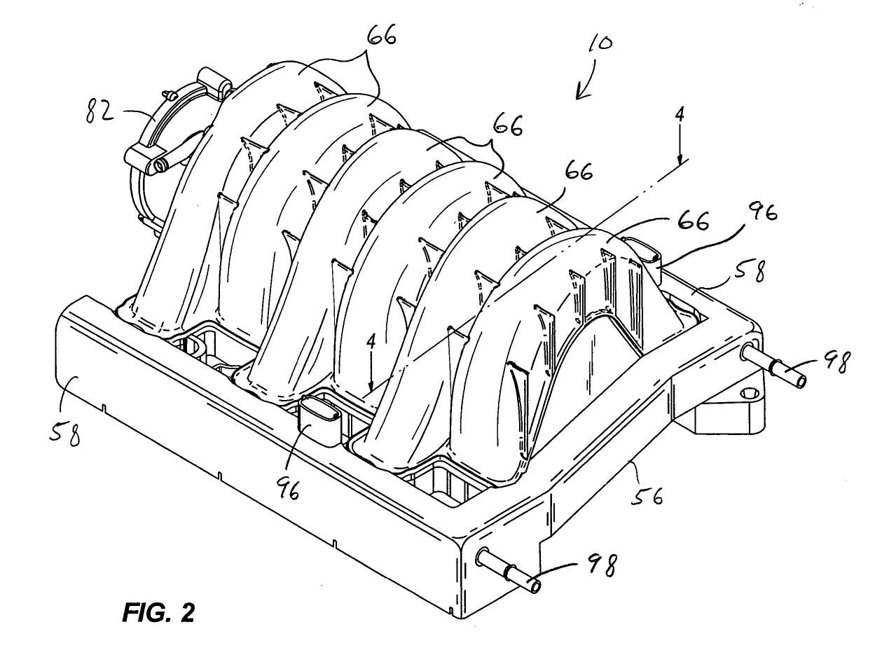

As shown in FIGS. 2 and 3, each of the fuel rails 26 includes a fuel rail inlet 98 to fluidly connect with one or more fuel lines (not shown) leading to a fuel tank (also not shown). The fuel rail assemblies 14 are molded into the intake manifold 56 such that the fuel rail inlets 98 protrude from the rear of the intake manifold 56 to provide fluid communication between the fuel passageways 30 and the one or more fuel lines. The fuel rail inlets 98, in the illustrated construction, are configured to receive a conventional locking plug-in connector (not shown) to fluidly connect with the fuel lines. However, the fuel rail inlets 98 may be configured in any of a number of different ways to receive different styles of connectors.

In the illustrated construction, the fuel rails 26 receive fuel independently of one another. However, in other constructions of the intake manifold assembly 10, a crossover line (not shown) may be used to fluidly connect the two fuel rails 26 such that only one fuel rail inlet 98 is required. Further, the crossover line may or may not be molded into the intake manifold 56.

As shown in FIG. 1, forward ends 102 of the fuel rails 26 protrude outside the intake manifold 56. The forward ends 102 are sealed with end caps 104. However, in other constructions of the intake manifold assembly 10, the forward ends 102 need not protrude outside the intake manifold 56.

As also illustrated in FIGS. 1-5, the electrical bus-bar 46 is also at least partially, and preferably substantially entirely molded into the intake manifold 56. As shown in FIGS. 4 and 5, only the multi-pin terminal 54 of each bus-bar 46 protrudes outside of the intake manifold 56. This is to allow the electrical connection between the fuel injectors 22 and the multi-pin terminals of the fuel injector harness. Since the multi-pin terminal 54 is the only portion of each bus-bar 46 to be exposed outside the intake manifold 56, electrical interference due to the harsh environment of the engine compartment is reduced. Also, since each bus-bar 46 allows (in the illustrated construction) electrical connection to three fuel injectors 22 with one multi-pin terminal 54, the number of connector plugs on the fuel injector harness may be reduced.

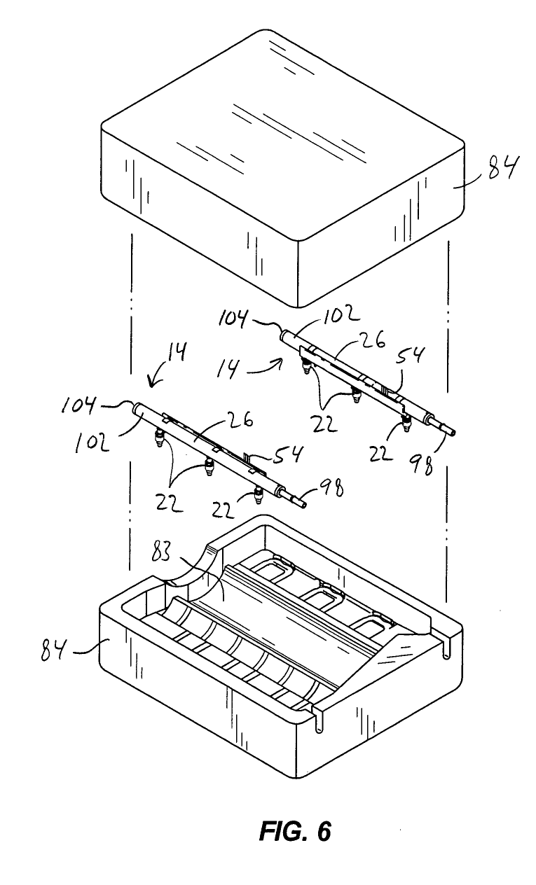

The intake manifold assembly 10 also provides a simplified manufacturing process compared to a conventional intake manifold assembly. With reference to FIG. 6, the pre-assembled fuel rail assemblies 14 are positioned in a mold cavity 83 defined by opposing mold halves 84. The mold cavity 83 is configured to form at least a portion of the intake manifold 56. The fuel rail assemblies 14 may be assembled as described above and as described in the '658 Application. However, the fuel rail assemblies 14 need not be separately overmolded, as described in the '658 Application. With the mold halves 84 closed, the plastic intake manifold material is injected into the cavity 83, thereby surrounding and insert molding the fuel rail assemblies 14 while forming at least a portion of the intake manifold 56. In the illustrated construction, the fuel rail assemblies 14 are molded into the base portions 58 of the intake manifold 56.

As a result, the seals that would normally be required in conventional intake manifold assemblies (i.e., the seals for the fuel passageway/fuel injector inlet interface and for the fuel injector outlet/intake manifold interface) are no longer required since the plastic material surrounding the fuel rail assemblies 14 performs the function of sealing each fuel passageway/fuel injector inlet interface and each fuel injector outlet/intake manifold interface. Not only does this allow the component count of the intake manifold assembly 10 to decrease, but it also allows the steps of positioning the seals relative to each fuel passageway/fuel injector inlet interface and each fuel injector outlet/intake manifold interface to be eliminated.

In addition, since the fuel rail assemblies 14 are insert molded with the intake manifold 56, the fuel injectors 22 are rigidly maintained in relation to their respective intake runners 66. Therefore, supporting structure connecting the fuel rails 26 to the intake manifold 56 (e.g., brackets, fasteners, and inserts in the intake manifold for receiving the fasteners) may also be eliminated. Further, the conventional steps of positioning the fuel injectors 22 in the intake manifold, positioning the fuel rails onto the fuel injectors 22, and securing the fuel rails to the intake manifold are also eliminated.

Several other benefits arise from having the “air path” (including the air inlet tube 78 and the intake runners 66), the “fuel path” (including the fuel rails 26/fuel passageways 30 and the fuel injectors 22), and the “electrical path” (including the bus-bars 46) combined into one assembly. One benefit, for example, is that the intake manifold assembly 10 can be packaged much more compactly compared to a conventional intake manifold assembly. This allows the intake manifold assembly 10 to more easily fit within vehicles having little under-hood room. Another benefit is that tolerances between the individual components of the intake manifold assembly 10 may be eliminated by reducing the manufacturing assembly variability.

In the illustrated construction (see FIGS. 3 and 4), the intake manifold 56 is comprised of three pieces; an upper shell 86, a middle shell 90, and a lower shell 94. The fuel rail assemblies 14 are molded into the middle shell 90 of the intake manifold 56. Like the middle shell 90, the upper shell 86 and the lower shell 94 may also be molded in respective mold cavities. After the upper, middle, and lower shells 86, 90, 94 are molded, they may be coupled together to form the intake manifold assembly 10. In the illustrated construction, the upper shell 86 may be coupled to the middle shell 90 by a process such as vibration welding or laser welding. Also, any number of different adhesives may also be used to bond the upper shell 86 and the middle shell 90. Additionally, the upper shell 86 and the middle shell 90 could be coupled together via a snap-fit engagement. The lower shell 94 may be coupled to the middle shell 90 by the same processes of vibration welding, laser welding, using adhesives, or snap-fit engagements.

The middle shell 90 includes the throttle body flange 82 and the air inlet tube 78. The fuel rail assemblies 14 are molded into this portion of the intake manifold 56 such that the elongated electrical leads 50 are insulated within the intake manifold 56, and the multi-pin terminals 54 protrude outside the intake manifold 56 to electrically connect with mating multi-pin terminals of a fuel injector harness (not shown). Each multi-pin terminal 54 is surrounded by a connector plug 96, which is integrally formed with the middle shell 90. The connector plugs 96 may include quick-disconnect or snap-fit structure to engage mating connector plugs (not shown) containing the multi-pin terminals of the fuel injector harness.

The middle shell 90 also defines lower portions 106 of the intake runners 66. As shown in FIG. 3, the lower portions 106 of the intake runners 66 provide structural support to the air inlet tube 78. The upper shell 86 defines upper portions 110 of the intake runners 66 and is coupled to an upper portion of the middle shell 90 such that the combination of the lower portions 106 and the upper portions 110 together define the intake runners 66. The lower shell 94 is coupled to a lower portion of the middle shell 90 such that the combination of the lower shell 94 and the middle shell 90 together define the plenum 70.

The upper shell 86, middle shell 90, and lower shell 94 may be molded using a plastic material such as glass-filled nylon (e.g., PA6, PA66, or PA46). However, other plastic or composite materials may also be used, and the upper shell 86, middle shell 90, and the lower shell 94 may also be made from different plastic materials. Further, the upper shell 86 and the lower shell 94 may be formed from metal by a process such as stamping, and coupled to the middle shell 90 in any of a number of different ways.

In other constructions, the intake manifold 56 may be comprised of any number of shells or may be formed as one piece. Further, the intake manifold 56 may be constructed and/or configured differently than that illustrated in the appended drawings, provided that the fuel injectors 22 are at least partially, and more preferably entirely, molded into the intake manifold 56. Such alternative constructions and/or configurations of the intake manifold 56 are also considered within the scope of the present invention.

Various features of the invention are set forth in the following claims.

1. An intake manifold assembly comprising:
an intake manifold including an intake passageway; and
a fuel injector in communication with the intake passageway, at least a portion of the fuel injector being molded into the intake manifold.

2. The intake manifold assembly of claim 1, wherein the intake manifold has a fuel passageway defined therein, the fuel passageway being in communication with the fuel injector.

3. The intake manifold assembly of claim 2, wherein the fuel injector is entirely molded into the intake manifold such that liquid fuel transferred from the fuel passageway to the intake passageway via the fuel injector, and hydrocarbon emissions resulting from the transfer of fuel, are substantially prevented from leaking outside the intake manifold.

4. The intake manifold assembly of claim 2, further comprising a fuel rail defining the fuel passageway, at least a portion of the fuel rail being molded into the intake manifold.

5. The intake manifold assembly of claim 4, wherein the fuel passageway is in communication with a fuel inlet of the fuel injector, and wherein an interface between the fuel rail and the fuel inlet of the fuel injector is molded into the intake manifold.

6. The intake manifold assembly of claim 5, wherein the fuel injector is coupled to the fuel rail without using a seal adjacent the interface.

7. The intake manifold assembly of claim 4, wherein the fuel rail includes a fuel rail inlet extending from the intake manifold.

8. The intake manifold assembly of claim 1, wherein the intake manifold includes:
a middle shell;
an upper shell coupled to an upper portion of the middle shell; and
a lower shell coupled to a lower portion of the middle shell.

9. The intake manifold assembly of claim 8, wherein a combination of the middle shell and the lower shell defines in part a plenum.

10. The intake manifold assembly of claim 8, wherein a combination of the upper shell and the middle shell defines in part the intake passageway.

11. The intake manifold assembly of claim 8, wherein the fuel injector is at least partially molded into the middle shell.

12. The intake manifold assembly of claim 1, further comprising an electrical connector coupled to the fuel injector, the electrical connector being at least partially molded into the intake manifold.

13. The intake manifold assembly of claim 1, wherein a fuel outlet of the fuel injector is in communication with the intake passageway to selectively deliver fuel to the intake passageway, and wherein the fuel outlet is molded into the intake manifold.

14. The intake manifold assembly of claim 13, wherein the fuel outlet of the fuel injector is molded into the intake manifold without using a seal adjacent the fuel outlet.

15. A method of manufacturing an intake manifold assembly, the method comprising:
providing a fuel injector;
inserting the fuel injector into a mold cavity; and
forming at least a portion of an intake manifold in the mold cavity such that at least a portion of the fuel injector is molded into the intake manifold.

16. The method of claim 15, further comprising forming a fuel passageway in the intake manifold.

17. The method of claim 16, wherein forming the fuel passageway includes molding at least a portion of a fuel rail into the intake manifold, the fuel rail defining the fuel passageway.

18. The method of claim 15, further comprising:
providing a fuel rail; and
coupling the fuel injector to the fuel rail.

19. The method of claim 18, wherein the fuel injector is coupled to the fuel rail without using a seal between the fuel injector and the fuel rail.

20. The method of claim 18, wherein coupling the fuel injector to the fuel rail includes one of laser welding, TIG welding, and brazing.

21. The method of claim 18, wherein inserting the fuel injector into the mold cavity includes inserting the fuel rail into the mold cavity such that at least a portion of the fuel rail is molded into the intake manifold.

22. The method of claim 15, wherein forming at least a portion of the intake manifold includes insert molding the entire fuel injector into the manifold such that liquid fuel provided to the fuel injector, liquid fuel discharged by the fuel injector, and hydrocarbon emissions resulting from evaporation of the fuel provided to the fuel injector and the fuel discharged by the fuel injector are substantially prevented from leaking outside of the intake manifold.

23. The method of claim 15, wherein forming at least a portion of the intake manifold includes
forming a middle shell;
forming an upper shell; and
coupling the upper shell to the middle shell to define at least part of an intake passageway.

24. The method of claim 23, wherein coupling the upper shell to the middle shell includes one of welding, bonding, and using a snap-fit engagement.

25. The method of claim 23, further comprising:
forming a lower shell; and
coupling the lower shell to the middle shell to define at least part of a plenum.

26. The method of claim 25, wherein coupling the lower shell to the middle shell includes one of welding, bonding, and using a snap-fit engagement.

27. The method of claim 15, wherein the fuel injector is molded into the intake manifold without using a seal between the fuel injector and the intake manifold.

28. The method of claim 15, further comprising:
coupling an electrical connector to the fuel injector; and
molding at least a portion of the electrical connector into the intake manifold.

29. The method of claim 15, further comprising:
providing a fuel rail;
coupling the fuel injector to the fuel rail;
providing an electrical connector;
coupling the electrical connector to the fuel injector; and
wherein forming at least a portion of the intake manifold further includes molding substantially the entire fuel injector, at least a portion of the fuel rail, and at least a portion of the electrical connector into the intake manifold such that liquid fuel provided to the fuel injector, liquid fuel discharged by the fuel injector, and hydrocarbon emissions resulting from evaporation of the fuel provided to the fuel injector and the fuel discharged by the fuel injector are substantially prevented from leaking outside of the intake manifold.

30. An intake manifold assembly comprising:
an intake manifold having an intake passageway; and
a fuel rail assembly including
a fuel injector having a fuel inlet and a fuel outlet, the fuel outlet being in communication with the intake passageway;
a fuel rail defining a fuel passageway in communication with the fuel inlet; and
an electrical connector coupled to the fuel injector;
wherein the electrical connector is at least partially molded into the intake manifold; and
wherein an interface between the fuel passageway and the fuel inlet is molded into the intake manifold, and wherein the fuel outlet is molded into the intake manifold such that liquid fuel transferred from the fuel passageway to the intake passageway via the fuel injector, and hydrocarbon emissions resulting from the transfer of fuel, are substantially prevented from leaking outside the intake manifold.

31. The intake manifold assembly of claim 30, further comprising a second fuel rail assembly at least partially molded into the intake manifold.

32. An engine assembly comprising:
an engine having a cylinder head; and
an intake manifold coupled to the cylinder head, the intake manifold defining
an air path for providing intake air to the cylinder head;
a fuel path for providing fuel to the cylinder head; and
an electrical path for providing power to a fuel injector;
wherein each of the air path, the fuel path, and the electrical path are at least partially molded into the intake manifold.

33. The engine assembly of claim 32, wherein the fuel path includes a fuel injector, the fuel injector being at least partially molded into the intake manifold.

34. The engine assembly of claim 32, wherein the fuel path includes a fuel passageway defined in the intake manifold.

35. The engine assembly of claim 34, wherein the fuel passageway is defined by a fuel rail at least partially molded into the intake manifold.

36. The engine assembly of claim 32, wherein the air path includes an intake passageway formed during molding of the intake manifold.

37. The engine assembly of claim 32, wherein the electrical path includes a bus-bar at least partially molded into the intake manifold.
